(19) United States
(12) Patent Application Publication
(10) Pub. No.: US 2004/0015403 A1
(43) Pub. Date: Jan. 22, 2004

(54) Method, system, and business method for wireless fast business

(75) Inventors: Paul A. Moskowitz, Yorktown Heights, NY (US); Stephen J. Boies, Mahopac, NY (US); Samuel Dinkin, Austin, TX (US); Philip S. Yu, Chappaqua, NY (US)

Correspondence Address: BUCKLEY, MASCHOFF, TALWALKAR, & ALLISON, 5 ELM STREET, NEW CANAAN, CT, 06840, US

(73) Assignee: International Business Machines Corporation, Armonk, NY (US)

(21) Appl. No.: 09/740,941

(22) Filed: Dec. 21, 2000

(51) Int. Cl. G06F 17/60

(52) U.S. Cl. 705/26

(57) ABSTRACT

A method, system, business method, and computer program product are disclosed for providing to customers and merchants a quick and automatic way to carry out an offer, acceptance, and delivery sequence for goods. The customer possesses a portable wireless device having a browser for exchanging data with the merchant, and includes a customer database that stores the customer's private data concerning preferences for merchandise and services available from the merchant. The merchant possesses a fixed position wireless device which the merchant uses to communicate with the customer. The merchant's device has a network interface to a server. The server includes a merchant database that stores merchandise and service information. When the merchant's fixed position wireless device detects the presence of the customer's nearby portable wireless device, the merchant's device sends the merchant's menu of goods and/or services to the customer's device and requests the customer's data relating to customer preferences and past transactions with the merchant. Such customer data includes the types of merchandise previously purchased, the customer's preferences, the dates of recent purchases, etc. The customer data is stored in the customer's private database in the customer's portable wireless device. If the customer places an order and provides a payment authorization using the portable device, the merchant's server processes the order and the payment authorization and then issues a control signal to a warehouse and dispensing mechanism to deliver the goods to the customer.

### FIELD OF THE INVENTION

The invention disclosed broadly relates to computer networks and more particularly relates to E-Commerce applications in pervasive computing networks.

### BACKGROUND

The traditional relationship between a customer and a merchant requires a manual offer, acceptance, and delivery sequence, wherein the merchant presents a description of the merchandise or services available, the customer places an order accompanied by a payment, the merchant accepts the order, receives the payment, and then transfers the goods or services to the customer. Even in accelerated mercantile scenarios such as fast food restaurants, this manual offer, acceptance, and delivery sequence must be carried out. The prior art needs a way of enabling a customer and merchant to quickly and automatically carry out the offer, acceptance, and delivery sequence.

### SUMMARY

The problems of the prior art are solved by the disclosed method, system, business method, and computer program product for providing customers and merchants to quickly and automatically carry out the offer, acceptance, and delivery sequence for goods and services. The method, system, business method, and computer program product is applied in a pervasive computing network, such as one implementing the Bluetooth standard. The method, system, business method, and computer program product can also be applied to wireless personal digital assistants (PDAs) and wireless telephones implementing the Wireless Application Protocol (WAP) standard.

In accordance with the method, system, business method, and computer program product, the customer possesses a Bluetooth-enabled portable wireless insitu device having a browser for exchanging data with the merchant. The customer's device includes a customer database that stores the customer's private data the customer's preferences for merchandise and services which can be bought from the merchant. The merchant possesses a Bluetooth-enabled fixed position wireless device which the merchant uses to communicate with the customer. Bluetooth-enabled wireless devices have a short communicating range of less than one-hundred meters. Both the customer's wireless device and the merchant's wireless device periodically transmit a short range identity signal. When the merchant's fixed position wireless device detects the presence of the customer's nearby portable wireless device, the merchant's device sends the merchant's menu of goods and/or services to the customer's device and requests the customer's data relating to customer preferences and past transactions with the merchant. Such customer data includes the types of merchandise previously purchased, the customer's preferences, the dates of recent purchases, etc. The customer data is stored in the customer's private database in the customer's portable wireless device. The customer's device may be used as an insitu device in which the customer's device is located within a specific store, or other location, in which the customer's device is used or places an order.

The merchant's fixed position wireless device has a local area network interface to the server. The server includes a merchant database that stores merchandise and service information for the merchant. The data in the merchant database is supplied by the merchant and includes the name of the merchandise, its base price, and inventory data of quantities on hand.

To insure that the customer or others cannot tamper with the customer data in the customer's device, the customer data is associated with a message authentication code (MAC). Items of value, such as the customer's credit card data, can be verified as having been properly issued on behalf of a bank, by means of the bank's digital signature appended to the credit card data in the customer's device.

If the customer places an order and provides a payment authorization using the portable device, the merchant's server processes the order and the payment authorization and then issues a control signal to a warehouse and dispensing mechanism to deliver the goods to the customer.

The resulting method, system, business method, and computer program product enables customers and merchants to quickly and automatically carry out the offer, acceptance, and delivery sequence for goods and services.

### DESCRIPTION OF THE FIGURES

FIG. 1 is a network diagram showing an example relationship between the customer's Bluetooth-enabled portable wireless device, two merchants' Bluetooth-enabled fixed position wireless devices, and the server.

FIG. 2A illustrates an example of the customer's private database and FIG. 2B illustrates an example of the server's merchant database.

FIG. 3 is a network flow diagram of the sequence of operational steps carried out by the customer's Bluetooth-enabled portable device, the merchant's fixed position device, and the server.

FIG. 4 is a server flow diagram of the steps for handling the customer's order data and for handling the bank's digital signature appended to customer's credit card data issued to the customer.

FIG. 5 is a functional block diagram of the server, showing the memory of the server storing the application services software programs needed to perform the operations of handling a customer order.

FIG. 6 is a network diagram wherein a merchant can deploy a plurality of Bluetooth-enabled fixed position wireless devices around the local store premises, for example along selected shopping aisles.

FIG. 7 is a network diagram of an alternate embodiment showing an example relationship between the customer's Wireless Application Protocol (WAP)-enabled portable wireless device 125, a WAP protocol gateway 140, and the server 100.

### DISCUSSION OF THE PREFERRED EMBODIMENT

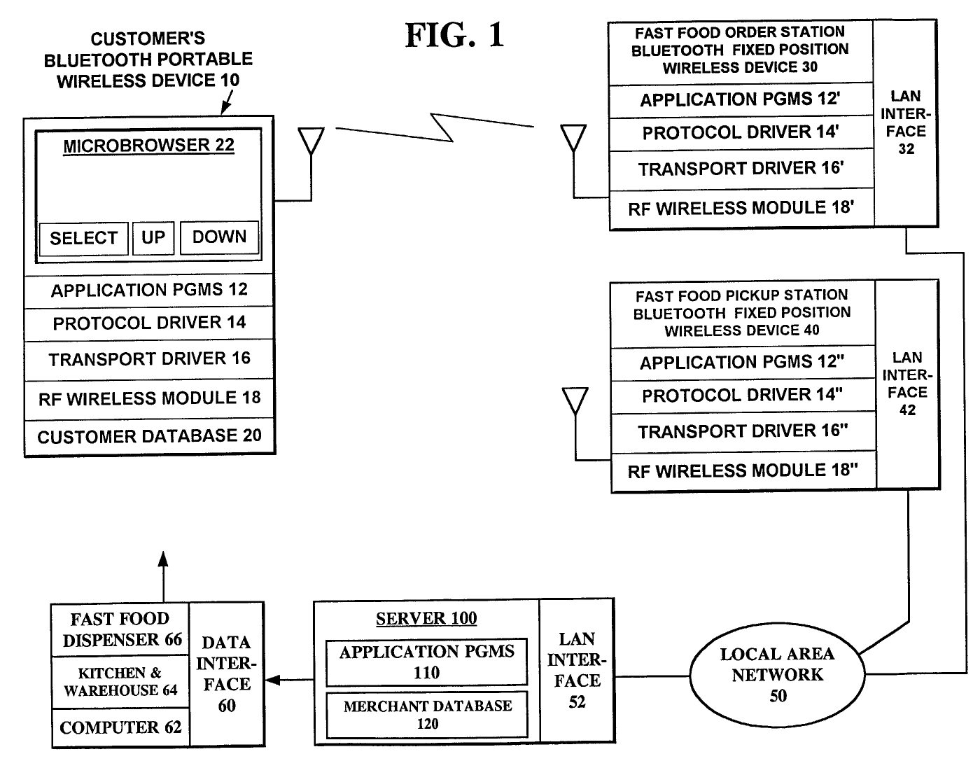

The method, system, business method, and computer program product is applied in a pervasive computing network, such as one implementing the Bluetooth™ standard. (“Bluetooth” is a trademark owned by Telefonaktielbolaget L M Ericsson, Sweden.) FIG. 1 is a network diagram showing an example relationship between the customer's Bluetooth-enabled portable wireless device 10, two merchants' Bluetooth-enabled fixed position wireless devices 30 and 40, and the server 100.

The Bluetooth standard is named after King Harald Blaatand (Bluetooth II), who was the king of Denmark and Norway during the Viking era (940-981 AD). The Bluetooth standard is a short-range wireless communication industry specification that allows portable, personal devices to interact which each other and other stationary devices. The Bluetooth standard uses the spread spectrum radio frequency and provides omnidirectional multiple connections without requiring communicating devices to be in line of sight. The maximum range is 10 meters, but it can be extended to 100 meters by increasing the power. When one Bluetooth device comes within range of another, they automatically exchange address and capability details. They can then establish a 1-megabit/second link with security and error correction. The device's radio operates on the globally available, unlicensed 2.45 GHz radio band, and supports data speeds of up to 721 Kbps. Each device has a unique 48-bit address similar to that provided in the IEEE 802 standard. Connections can be point-to-point or multipoint. Bluetooth devices are protected from radio interference by changing their frequencies randomly up to a maximum of 1600 times per second, using a frequency hopping protocol. They also use three different but complimentary error correction schemes. Built-in encryption and verification are provided. Bluetooth devices provide a universal bridge to existing data networks, a peripheral interface, and a mechanism to form small private ad hoc groupings of connected devices away from fixed network infrastructures. Bluetooth radio modules avoid interference from other signals by hopping to a new frequency after transmitting or receiving a packet.

The Bluetooth specification is a de facto standard containing the information required to ensure that diverse devices supporting the Bluetooth wireless technology can communicate with each other worldwide. The document is divided into two parts: Volume 1: Core, and Volume 2: Profiles. The Core part specifies components such as the radio, baseband, link manager, service discovery protocol, transport layer, and interoperability with different communication protocols. The Profiles part specifies the protocols and procedures required for different types of Bluetooth applications. A copy of the Bluetooth Specification can be downloaded from the Internet web site http://www.bluetooth.com/developer/specification/specification.asp. Additional information is provided in the book by Brent A. Miller and Chatschik Bisbikian entitled “Bluetooth Revealed”, published by Prentis Hall, 2000 (ISBN 0130902942).

In the network diagram of FIG. 1, an example relationship is shown between the customer's Bluetooth-enabled portable wireless device 10, a fast food restaurant's order station's Bluetooth-enabled fixed position wireless device 30, the fast food restaurant's Bluetooth-enabled fixed position wireless device 40, and the server 100. The customer's Bluetooth-enabled portable wireless device 10 is shown having the form of a hand-held personal digital communicator, with an LCD display and a touch overlay screen to enable inputting commands to the microbrowser 22 by touching the potion of the screen displaying the appropriate input button. The Bluetooth-enabled portable wireless device 10 includes a programmed central processor, a memory, at least a few alphanumeric input keys, and an RF wireless transceiver module 18. The memory of the Bluetooth-enabled portable wireless device 10 stores application programs 12, protocol driver 14, transport driver 16, and a customer database 20.

The customer's Bluetooth-enabled portable wireless device 10 receives and sends data over a short radio link with the merchant's wireless device 30, for example. The microbrowser 22 displays control buttons “UP”, “DOWN”, and “SELECT”, to enable the customer to navigate through the pages of data being displayed and to select options that are presented by the microbrowser 22.

The Wireless Application Protocol (WAP) standard can be used in the application program layer 12 of the Bluetooth-enabled portable wireless device 10, to provide functionality for the device's microbrowser 22. The customer's Bluetooth-enabled portable wireless device 10 accesses a small file called a deck which is composed of several smaller pages called cards which are small enough to fit into the display area of the device's microbrowser 22. The small size of the microbrowser 22 and the small file sizes accommodate the low memory constraints of the Bluetooth-enabled portable wireless device 10 and the low-bandwidth constraints of a wireless network. The cards are written in the Wireless Markup Language (WML) which is specifically devised for small screens and one-hand navigation without a keyboard. The WML language is scaleable from two-line text displays on a small screen microbrowser 22, up through graphic screens such as are found on personal communicators. The cards written in the WML language can include programs written in WMLScript, which is similar to JavaScript, but makes minimal demands on memory and CPU power of the Bluetooth-enabled portable wireless device 10 because it does not contain many of the unnecessary functions found in other scripting languages. A discussion of the WAP standard is given below in connection with the alternate embodiment directed to WAP-enabled wireless telephones.

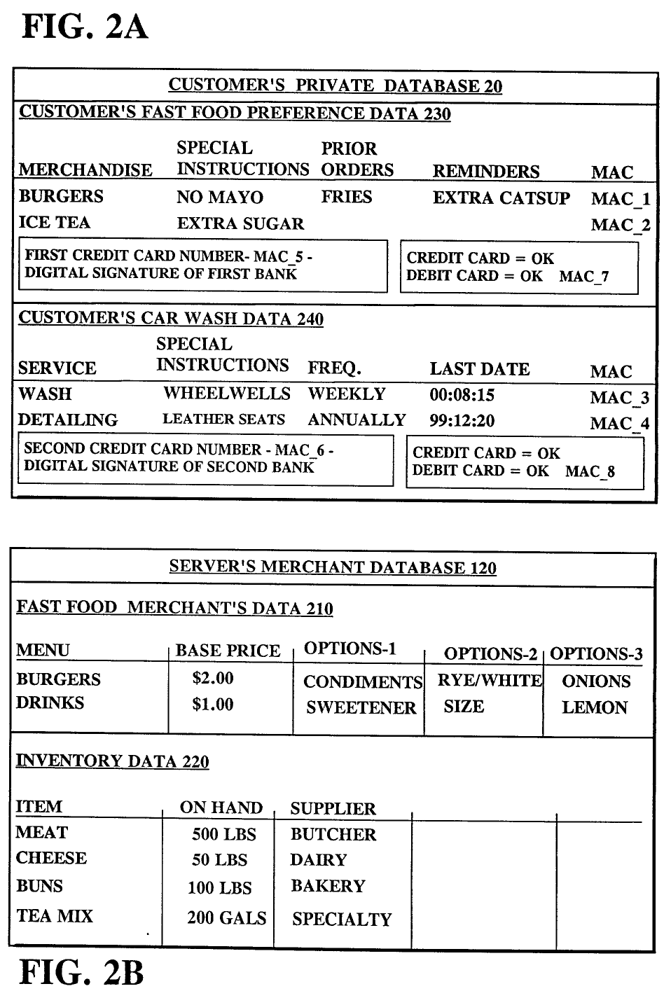

The customer's device 10 includes a customer database 20 that stores the customer's private data concerning preferences for merchandise and services bought from the merchant in the past. FIG. 2A illustrates an example of the customer's private database. The customer's data can be compiled by the merchant and sent to the customer during prior purchasing transactions.

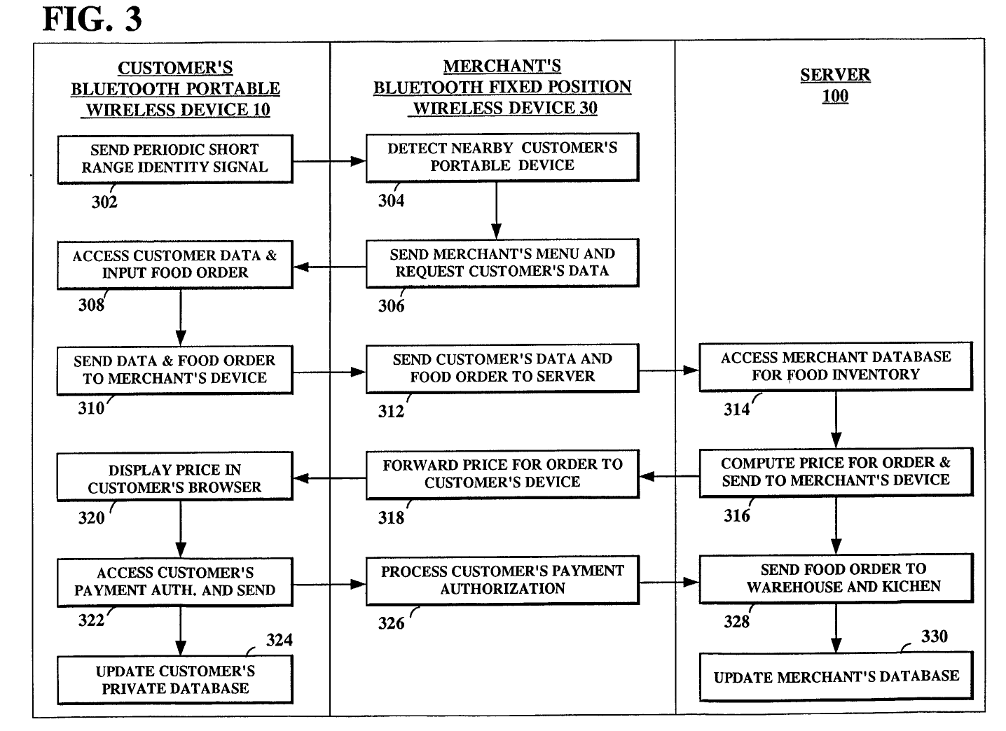

The application programs 12 in the customer's Bluetooth-enabled portable wireless device 10 are described in the flow diagram of FIG. 3. In FIG. 3 the application programs 12 include the steps 302, 308, 310, 320, 322, and 324. These programmed steps will be described in further detail below.

The protocol driver 14 in the customer's Bluetooth-enabled portable wireless device 10 includes the Bluetooth core protocols of Baseband, Link Manager Protocol (LMP), Logical Link Control and Adaptation Protocol (L2CAP), and Service Discovery Protocol (SDP) and the Bluetooth serial cable emulation protocol (RFCOMM). The Baseband and Link Control layers enable the physical RF link through the RF wireless module 18, between the Bluetooth devices 10, 30, and 40 forming a piconet RF network, coordinating the frequency-hopping spread spectrum system in which packets are transmitted in defined time slots on defined frequencies. A piconet RF network consists of one master Bluetooth device and up to seven active member Bluetooth devices. A Bluetooth network of multiple piconets is called a scatternet. The Link Manager Protocol (LMP) sets up the links between the Bluetooth devices 10, 30, and 40. The Logical Link Control and Adaptation Protocol (L2CAP) provides data services to the upper layer protocols permitting them to transmit and receive data packets up to 64 kilobytes in length. The Service Discovery Protocol (SDP) enables a Bluetooth device 10 to discover available supporting services to enable it to connect to other Bluetooth devices 30 and 40. RFCOMM is an RS 232 serial emulation protocol that provides transport capabilities for upper level services that emulate a serial line as the transport mechanism. Other Bluetooth standard protocols can be included to support the applications of file transfer, Internet bridge, LAN access, information synchronization, multiple service provider telephony, and wireless headset functions. The Bluetooth protocol drivers 14′ and 14″ in devices 30 and 40 have similar features to those of the protocol driver 14.

An example implementation of the Bluetooth protocol driver 14 is the IBM BlueDrekar™ protocol stack which includes the RFCOMM, SDP, and L2CAP protocols and the hardware controller interface (HCI) to the transport driver 16. (BlueDrekar is a trademark of International Business Machine Corp.) The drekar was a class of medieval, dragon-headed longships sailed by the Vikings. A description of the IBM BlueDrekar protocol stack is provided at the Internet web site http://www.alphaworks.ibm.com/tech/bluedrekar.

The transport driver 16 in the customer's Bluetooth-enabled portable wireless device 10 includes the host controller firmware and a standardized interface to the RF wireless module 18. An example standardized interface is the RS232 serial device interface, enabling the exchange of control and data between the protocol driver 14 and the RF wireless module 18. Other standard interfaces for the Bluetooth transport driver 16 include the Universal Serial Bus (USB) and Universal Asynchronous Receiver-Transmitter (UART) protocols. The transport drivers 16′ and 16″ in devices 30 and 40 have similar features to those of the transport driver 16.

An example implementation of the Bluetooth transport driver 16 is the IBM BlueDrekar HCI UART transport driver. This transport driver for the BlueDrekar middleware is a reference implementation of the Bluetooth Host Controller Interface (HCI) Universal Asynchronous Receiver-Transmitter (UART) transport layer. A description of the IBM BlueDrekar HCI UART transport driver is provided at the Internet web site http://www.alphaworks.ibm.com/tech/bluedrekar.

The fast food merchant possesses a Bluetooth-enabled fixed position wireless device 30 which the merchant uses to communicate with the customer at a fast food order station. The fast food merchant's Bluetooth-enabled portable wireless device 30 includes application programs 12′, protocol driver 14′, transport driver 16′, and RF wireless module 18′. The fast food merchant's Bluetooth-enabled portable wireless device 30 is connected by means of the local area network (LAN) interface 32 to the local area network 50, which can be a TCP/IP network such as the Internet, or an Ethernet network, for example.

The fast food merchant possesses a second Bluetooth-enabled fixed position wireless device 40 which the merchant uses to communicate with the customer at a fast food pickup station. The fast food merchant's Bluetooth-enabled portable wireless device 40 includes application programs 12″, protocol driver 14″, transport driver 16″, and RF wireless module 18″. The fast food merchant's Bluetooth-enabled portable wireless device 40 is connected by means of the local area network (LAN) interface 42 to the local area network 50. The server 100 is connected by means of the local area network (LAN) interface 52 to the local area network 50.

Flow Diagram of Basic Sequence of Steps

FIG. 3 is a network flow diagram of the basic sequence of operational steps carried out by the customer's Bluetooth-enabled portable device 10, the fast food merchant's fixed position device 30, and the server 100. Bluetooth-enabled wireless devices have a short communicating range of less than one-hundred meters. The customer's wireless device 10 and the merchants' wireless devices 30, each periodically transmits a short range identity signal, as shown in step 302 of FIG. 3. When the merchant's fixed position wireless device 30, for example, detects the presence of the customer's nearby portable wireless device 10 in step 304, the merchant's device 30 sends the merchant's menu of available goods and services to the customer's device 10 and requests the customer's data relating to customer preferences and past transactions with the merchant, as shown in step 306. The customer's device 10 includes a customer database 20 that stores the customer's private data concerning preferences, merchandise and services bought from the merchant in the past. FIG. 2A illustrates an example of the customer's private database. The customer's device 10 accesses the customer data relating to the merchant, in step 308. If the customer wishes to place a food order, for example, the customer uses the selection keys and the microbrowser 22 on the device 10 to input the order. Then the device 10 forwards the customer data and the food order to the merchant's fixed position wireless device 30 in step 310. The merchant's fixed position wireless device 30 then sends the customer's data and the food order to the server 100 in step 312. The merchant's fixed position wireless device 30 has a local area network interface 32 to the local area network 50 and the server 100.

The customer's private database 20 shown in FIG. 2A, includes information characterizing purchasing preferences and past transactions of the customer with several merchants, including the fast food merchant. The customer's fast food preference data 230 includes the identity or class of the merchandise, special instructions, information on prior orders, reminders, and other information related to purchasing the identified item of merchandise. Additionally, information is stored in the customer's fast food preference data 230 identifying the type of payment methods that the customer is qualified to use, such as credit card, debit card, E-Cash, and the like. Any preferences for one method of payment over another is recorded in the data 230. Also, if there has been any difficulty with consummating the customer's payments in the past, such as a “not sufficient funds” status of a debit account, that information is also recorded in the data 230. Similar data is maintained in the database 20 for other merchants with whom the customer has done business, such as the car wash data 240. To insure the integrity of the customer's private data, so that the customer or others cannot conceal any tampering with it, the units of customer data are appended with a message authentication code (MAC) computed by the originator of the data, such as a bank. FIG. 2A shows a MAC stored in association with each unit of data in the database 20, such as MAC_1 for the burgers merchandise item in the customer's data 230. The customer's private database 20 can also store items of value, such as the customer's credit card data issued by the customer's bank. Credit card data can be verified as having been properly issued by the bank, by means of the bank digitally signing the coupons using the bank's private key. Each digital signature has been computed by the bank and the digital signature and the credit card data have been stored in the customer's database 20 in the customer's device 10. In addition, the integrity of the credit card data is authenticated with a MAC that the bank has computed and appended to the credit card data. FIG. 2A shows MAC_5 and the digital signature of the first bank associated with the first credit card number in the customer's fast food preference data 230.

The server 100 includes a merchant database 120 that stores merchandise and service menu information and inventory information. FIG. 2B illustrates an example of the server's merchant database. The menu data in the merchant database is supplied by the merchant, and includes the name of the merchandise, its base price, and options available. The server 100 accesses the merchant database 120 for food inventory status in step 314 of FIG. 3.

The server's merchant database 120 of FIG. 2B includes inventory information about the merchandise for sale. The merchant's data 210 includes the identity or class of merchandise, the base price, quantities on hand, and the name of the supplier. Additionally, information can stored in the merchant's data 210 identifying methods of payment which are acceptable to or prohibited by the merchant, such as credit card, debit card, or E-Cash, and the like. Any preferences for one method of payment over another is recorded in the data 210. For example, the merchant may not like paying the fixed percentage premium to the credit card companies for use of credit cards by the merchant's customers. This prohibition of credit cards as a method of payment can be recorded in the data 210. Merchants' cryptographic keys for use in processing message authentication codes (MACs) and digital signatures may be stored in a secure manner in the server's merchant database 120.

In accordance with the method, system, business method, and computer program product, the server 100 computes the price for a customer's order and payment methods for the customer in step 316 of FIG. 3, based on the customer's private data concerning merchandise and services bought from the merchant in the past. The computed price and payment methods are then sent by the server 100 to the merchant's fixed position wireless device 30, which then forwards this information in step 318 to the customer's device 10. The microbrowser 22 displays the price and payment method information and the customer uses the control buttons “UP”, “DOWN”, and “SELECT”, to input the customer's order and payment authorization in step 322 of FIG. 3. The customer's private database 20 can be updated at this time in step 324. Then, the customer's order is transmitted from the customer's device 10 to the merchant's fixed position wireless device 30 in step 326. The customer's order and payment authorization can be forwarded by the merchant's fixed position wireless device 30 to the merchant's order processing computer (not shown), where the customer's order and payment can be processed. In the alternative, The customer's order and payment authorization can be forwarded by the merchant's fixed position wireless device 30 to the server 100, where the customer's order and payment can be processed. The server then sends the food order to the warehouse and kitchen 64 in step 328 of FIG. 3, via the interface 60 and computer 62 of FIG. 1. The merchant database 120 can be optionally updated at this time in step 330 of FIG. 3.

Details of the Server

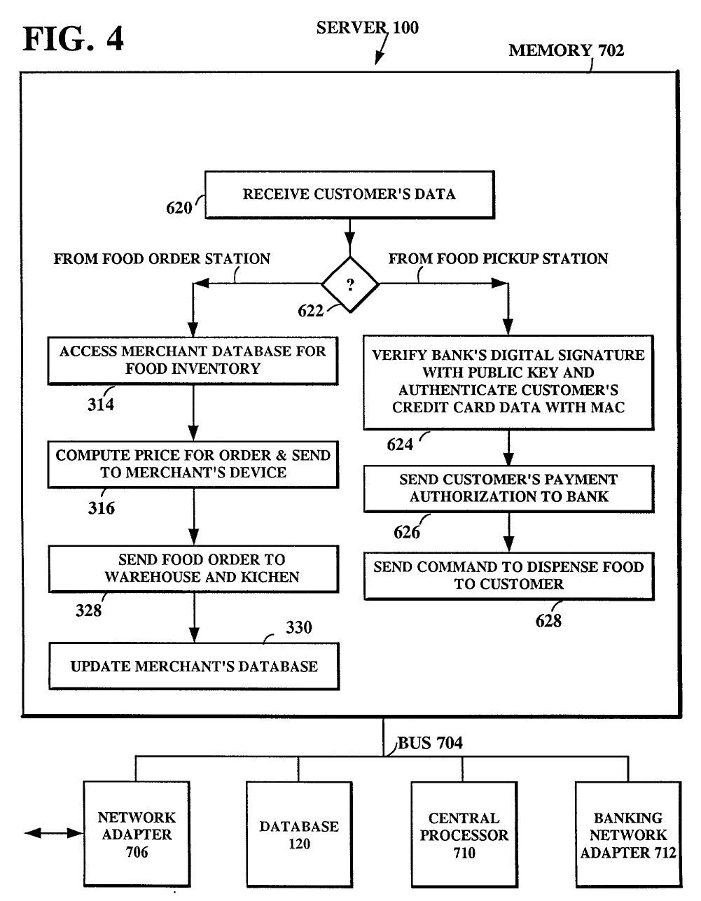

FIG. 4 shows a flow diagram of the steps in the method for the server 100 handling the customer's data and for handling the bank's digital signature and MAC appended to the customers credit card data. Step 620 receives the customer's data in the server 100. Then step 622 determines whether the data received from the food order station device 30 and if it is, the program flows to steps 314, 316, 328, and 330 which were previously described for FIG. 3. Alternately, if the data received is from the food pickup station device 40, then the program flows to steps 624, 626, and 628. Step 624 verifies the bank's digital signature with the bank's public key and authenticates the customer's credit card data with the MAC appended by the bank. Step 626 sends the customer's payment authorization to the bank. Step 628 sends a command to the fast food dispenser 66 to deliver the ordered food to the customer.

To insure the integrity of the customer's private data, so that the customer or others cannot conceal any tampering with it, the server associates the units of customer data with a message authentication code (MAC) computed by the server. The customer database 20 in the customer's device 10 includes message authentication codes (MAC) to insure the integrity of the associated data. Each MAC has been computed by the originator of the data, as will be described, for a corresponding unit of customer data and both the MAC and the customer data have been stored in the customer's database 20 in the customer's device 10. Methods to generate and evaluate message authentication codes to insure the integrity of data are described in the book by Stephen Thomas entitled “SSL and TLS”, published by John Wiley and Sons, 2000. Two example algorithms for message authentication are RSA's Message Digest (MD5) and the Secure Hash Algorithm (SHA), both of which are described in the book by Stephen Thomas. Another reference that goes into greater detail in its discussion of data integrity methods is the book by Bruce Schneier entitled “Applied Cryptography—2nd Edition” published by John Wiley and Sons, 1996.

Methods to generate and evaluate digital signatures to insure the source of the digital coupon are described in the book by Richard E. Smith entitled “Internet Cryptography”, published by Addison Wesley, 1997. The bank's private key of a public key/private key pair, is used to encrypt the customer's credit card data at the time it is issued, thereby uniquely signing the credit card data. Later, when the encrypted credit card data is presented by the customer to the server 100, only the bank's public key of the pair will be able to decrypt the credit card data and produce the cleartext data. This authenticates the bank as having authorized the issuance of the credit card data. One standard approach is to use the RSA public key algorithm at the server to generate the public key/private key pair. Another standard is the Digital Signature Algorithm (DSL) that signs hashed data produced by applying the Secure Hash algorithm (SHA) to the data in the coupon, both of which are described in the book by Richard E. Smith. Another reference that goes into greater detail in its discussion of digital signatures is the book by Bruce Schneier entitled “Applied Cryptography—2nd Edition” published by John Wiley and Sons, 1996. After the digital signature has been verified for the credit card in step 624 of FIG. 4, the server 100 authenticates the integrity of the customer's data in step 624, in the manner previously discussed. Then the server 100 sends the customer's payment authorization to the bank in step 626 of FIG. 4. Then the server 100 sends a command to the fast food dispenser 66 in FIG. 1 to dispense the food to the customer.

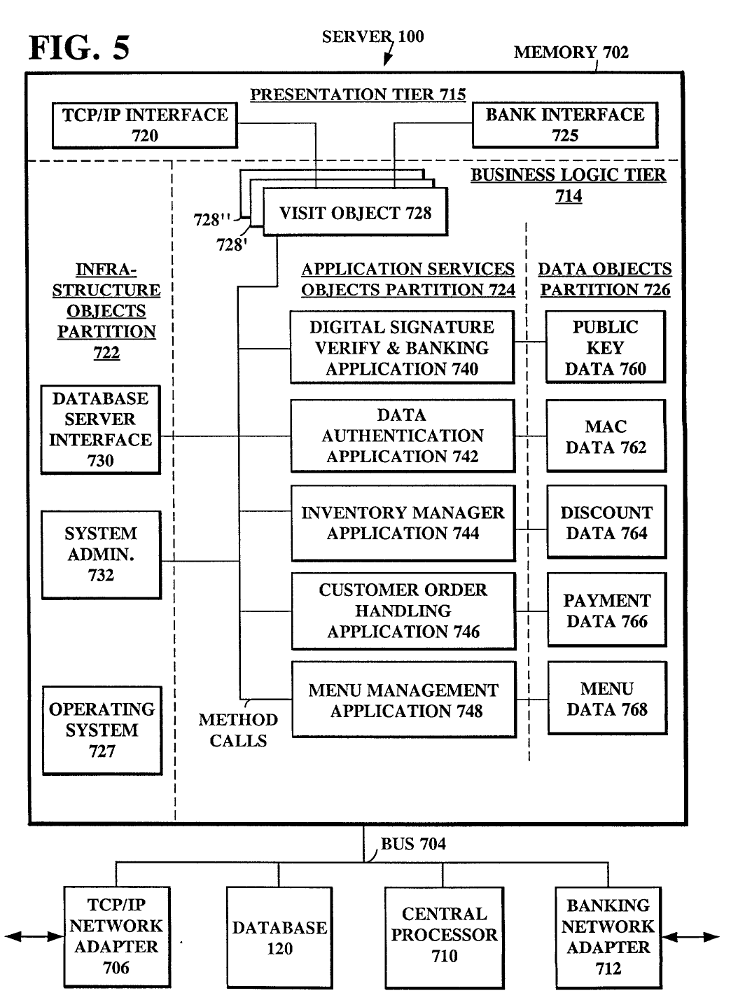

FIG. 5 is a functional block diagram of the server 100, showing the memory 702 of the server 100 storing components of software program objects needed to perform the operations of handling customized discounts and payment plans and handling digital coupons. The memory 702 of the server 100 is connected by the system bus 704 to the central processor 710 that executes the programmed instructions stored in the memory 702. Bus 704 is also connected to the merchant's database 120. The TCP/IP network adapter 706 is connected by the bus 704 to the memory 702, for connecting the server 100 to the LAN interface 52 and the local area network 50. The banking network adapter 712 is connected by the bus 704 to the memory 702, for connecting the server 100 to a private banking network and banking servers which can be used by the server 100 to check credit histories and to arrange for credit card, debit card, or E-Cash payments by the customer. The central processor 710 can be, for example, an IBM RS/6000 Enterprise Server, an IBM AS/400e Server, or the like.

FIG. 5 shows the various functional modules of the server 100 arranged in an object model. The object model groups the various object-oriented software programs into components which perform the major functions and applications in the server 100. Enterprise Java Beans (EJB) is a software component architecture for servers, which is suitable for embodying the object-oriented software program components of FIG. 5. A description of E-Commerce server programming applications developed with Enterprise Java Beans is provided in the book by Ed Roman entitled “Mastering Enterprise Java Beans”, published by John Wiley and Sons, 1999. A description of the use of an object model in the design of a web server for E-Commerce applications is provided in the book by Matthew Reynolds entitled “Beginning E-Commerce”, Wrox Press Inc, 2000, (ISBN: 1861003986). The components of object-oriented software programs in the object model of memory 702 are organized into a business logic tier 714, a presentation tier 715, and an infrastructure objects partition 722. The business logic tier 714 is further divided into two partitions: an application services objects partition 724 and a data objects partition 726. The Infrastructure objects partition 722 includes an object-oriented software program component for the database server interface 730, an object-oriented software program component for the system administrator interface 732, and the operating system 727. The operating system 727 can be, for example, IBM AIX, IBM OS/400, IBM OS/390, Microsoft Windows NT, Red Hat Linux, or Caldera Linux.

FIG. 5 shows the presentation tier 715 including a TCP/IP interface 720 and a bank interface 725. The presentation tier 715 manages the graphical user interface with the customer. A suitable implementation for the presentation tier 715 is with Java servlets to interact with the customer using the hypertext transfer protocol (HTTP). The Java servlets run within a request/response server, handling request messages from the customer and returning response messages to the customer. The Java servlet is a Java object that takes a request as input, parses its data, performs some logic, and then issues a response back to the customer. The Java servlets are pooled and reused to service many customer requests. The TCP/IP interface 720, implemented with Java servlets, functions as a web server that communicates with the customers using the HTTP protocol. The TCP/IP interface 720 accepts HTTP requests from the customer and passes the information in the request to the visit object 728 in the business logic tier 714. Result information returned from the business logic tier 714 is passed by the visit object 728 to the TCP/IP interface 720, which sends the results back to the customer in an HTTP response. The TCP/IP interface 720 exchanges data through the TCI/IP network adapter 706 and through the LAN interface 52 of server 100 with the merchant Bluetooth devices 30 and 40 and the customer's Bluetooth wireless device 10. Java servlets and the development of web site servers is described in the book by Duane K. Fields, et al. entitled “Web Development with Java Server Pages”, published by Manning Publications Co., 2000.

The business logic tier 714 in FIG. 5 includes multiple instances of the visit object 728, 728′, and 728″. Each customer's Bluetooth wireless device 10 that sends a message to the server 100 has a temporary and separate visit object 728 instantiated to represent the visit. The Enterprise Java Bean server can instantiate multiple copies of the visit object component 728 in the business logic tier 714 to handle multiple messages from multiple customers. Each visit object 728 will buffer customer-specific information and maintain a customer-specific state for the duration of the session with the customer. Each visitor object 728 is a stateful session bean that will hold the conversational state about the customer's visit. A stateful session bean is an Enterprise Java Bean that services business processes that span multiple method requests or transactions. The stateful session bean retains state on behalf of an individual customer. Data received by the server from the customer and data sent by the server to the customer will be temporarily buffered in the visitor object 728. Each visitor object 728 receives from the interface 720 the customer data sent by the merchant's wireless device 30 to the server 110 in step 312 of FIG. 3. Each visitor object 728 will also buffer the resulting price information which is computed by the server in step 316 of FIG. 3, and that price information is passed back to the TCP/IP interface 720. The order and payment information received from the customer in step 328 and the order data sent to the warehouse and kitchen in step 328 are temporarily buffered in the visitor object 728. A dedicated connection can alternately be provided between the server 100 and the data interface 60 of the computer 62 for the warehouse and kitchen.

When a message from one of the Bluetooth devices arrives at the LAN interface 52 of server 100 in step 620 of FIG. 4 and is received by the TCP/IP interface 720 in FIG. 5, a visit object 728 is instantiated and the received data is passed to the visit object 728. Depending on the state of the transaction in FIG. 4, the visit object 728 will send a method call to one of the object-oriented software program components in the application services objects partition 724. If the transaction is at step 314 of FIG. 4, then a an order has been received from the food order station device 30. The visit object 728 will then send a method call to the inventory manager application 744, followed by the customer order handling application 746. The visit object 728 will then pass the result data back to the TCP/IP interface 720 which will send the result data back to the merchant Bluetooth device 30 in step 316 of FIG. 4. Enterprise Java Beans support transaction processing, where a series of small operations are executed as one large, atomic operation. This allows multiple instantiations of the visitor object 728 representing multiple customers to share the same resource component, such as the digital signature verification application 740. When multiple calls are made on a method of the same resource component, the invocations are serialized and performed in lock-step. Any accesses to the merchant database 120 will be handled by the database server interface 730.

Alternately, if the state of the transaction is at step 624 of FIG. 4, then a customer's data with a MAC has been received. The visit object 728 will then send a method call to digital signature verification application 740 and the data authentication application 742. The digital signature verification application 740 will access public key data from the public key data object 760. The data authentication application 742 will access MAC data from the MAC data object 762. The visit object 728 will then pass the result data back to the TCP/IP interface 720 which will send the result data back to the merchant Bluetooth device 30 or 40.

FIG. 5 also shows the bank interface 725 in the presentation tier 715 that exchanges financial data with banks connected to the banking network through the banking network adapter 712 of server 100. The bank interface 725, implemented with Java servlets, functions as a web server that communicates with financial institutions using the HTTP protocol. The bank interface 725 accepts HTTP requests from the banks and passes the information in the request to the visit object 728 in the business logic tier 714. Result information returned from the business logic tier 714 is passed by the visit object 728 to the bank interface 725, which sends the results back to the banks in an HTTP response. When a message from one of the banks arrives at the banking network adapter 712 and is received by the bank interface 725 in FIG. 5, a visit object 728 is instantiated and the received financial data is passed to the visit object 728. This data may be the results of a credit check on a customer who has applied to a merchant for credit. The visit object 728 will send a message to the banking application 740 to process the received financial data. Any adjustments or updates to the server 100 can be performed by the system administrator through the system administrator interface 732.

An example software platform for implementing the functions performed by the server 100 of FIG. 5 is the IBM WebSphere Application Server (WebSphere is a trademark of the IBM Corporation.) The WebSphere Application Server is a Java-based Web application platform for managing Java-based E-commerce applications, accessing databases, and handling Internet transactions with remote clients and servers. A description of the WebSphere Application Server is provided in the book by Ron Ben-Natan and Ori Sasson entitled “IBM Websphere Starter Kit”, Osborne McGraw-Hill, 2000 (ISBN: 0072124075). An additional description can be found on the Internet web site http://www-4.ibm.com/software/developer/library/wsarchitecture/wsarchitecture.html.

Alternate Embodiments

[1] Bluetooth-Enabled Fixed Position Wireless Devices Along Shopping Aisles

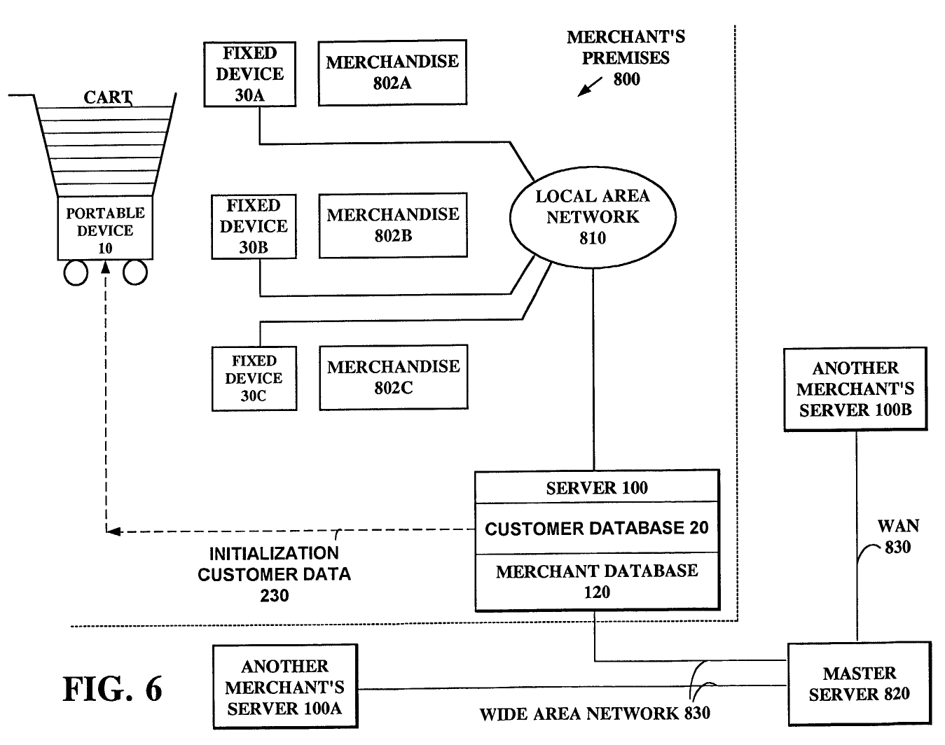

In an alternate embodiment shown in FIG. 6, the merchant can deploy a plurality of Bluetooth-enabled fixed position wireless devices 30A, 30B, and 30C around the local store premises 800, for example along selected shopping aisles. Each fixed position wireless device 30A, 30B, and 30C is located near a respective merchandise 802A, 802B, and 802C. The plurality of fixed position wireless devices 30A, 30B, and 30C are connected in a local area network (LAN) 810 to a local database on the store premises which stores or which can access the merchant database 120. As the customer's Bluetooth-enabled portable wireless device 10 is carried by the customer through each shopping aisle, the respective fixed position wireless device 30B, for example in that aisle will detect the proximity of the customer's device 10 and deliver a message to the customer's device 10 that is uniquely associated with the merchandise 802B on display in that aisle.

[2] Bluetooth-Enabled Portable Wireless Device Mounted on a Shopping Cart

In another alternate embodiment shown in FIG. 6, the Bluetooth-enabled portable wireless device 10 is mounted on a shopping cart at the local store premises 800 of the merchant. The memory within the Bluetooth-enabled portable wireless device 10 is not loaded with the customer database 20 until the customer initializes the portable wireless device 10 when he or she begins to use the shopping cart. The customer initializes the Bluetooth-enabled portable wireless device 10 by entering the customer's identity, such as an assigned customer number, or the customer's telephone number, driver's license number, or the like. The customer's identity is transmitted to a merchant's fixed position wireless device 30B at the local store premises, which is connected in a local area network (LAN) 810 to a local database on the store premises which stores or which can access a copy of the customer database 20. The data 230 in the customer database 20 is then loaded into the memory in the Bluetooth-enabled portable wireless device 10 mounted on the customer's shopping cart, thereby initializing the device 10. The grocery store merchant can deploy a plurality of fixed position wireless devices 30A, 30B, and 30C around the local store premises 800, for example along selected shopping aisles. The plurality of fixed position wireless devices 30A, 30B, and 30C are connected in the LAN 810 to the local database on the store premises which stores or which can access the merchant database 120. As the shopping cart's Bluetooth-enabled portable wireless device 10 is carried by the customer through each shopping aisle, the respective fixed position wireless device, for example 30B in that aisle will detect the proximity of the shopping cart's device 10 and deliver a message to the shopping cart's device that is uniquely associated with the merchandise 802B on display in that aisle.

[3] Broadcasting to a Plurality of Bluetooth-Enabled Portable Wireless Devices

In still another alternate embodiment shown in FIG. 6, the local merchant 800 having a server 100 is affiliated with a plurality of other grocery store merchants having other servers 100A and 100B in a consortium, such as a commonly owned grocery store chain. The servers 100, 100A, and 100B in each respective local grocery store are connected over a wide area network (WAN) 830 to a master merchant database in the master server 820, which accessible to each of the plurality of servers 100, 100A, and 100B in the commonly owned grocery store chain. A central authority, such as the common owner or manager of the grocery store chain, can broadcast special discounts and payment methods over the wide area network (WAN) 830 from the master server 820 to each of the plurality of servers 100, 100A, and 100B. The special discounts and payment methods are offered to customers via the Bluetooth-enabled portable wireless device 10. Alternately, the central authority can transmit over the wide area network (WAN) 830 from the master server 820 to an individual one of the servers, for example server 800, special discounts and payment methods to be offered only to customers patronizing that particular store 800, via the Bluetooth-enabled portable wireless device 10. The special discounts and payment methods can be broadcast to all of the customers in that particular store, or a point-to-point transmission can be made to an individual customer in that particular store.

[4] A Wearable Bluetooth-Enabled Portable Wireless Device

The customer's Bluetooth-enabled portable wireless device 10 can also be provided in the form of a wearable device, worn by the customer as a hands-free headset that includes an earphone, a microphone, and a heads-up image projector which is part of a pair of glasses worn with the headset. The image of the browser 22 is projected on the lenses of glasses worn by the customer. The customer's commands are input to the Bluetooth-enabled portable wireless device 10 by speaking the commands into the microphone and transforming the commands into digital information by means of a voice recognition program which is part of the application programs 12. Both visual and auditory messages can be presented to the customer by the Bluetooth-enabled portable wireless device 10.

[5] Wireless Telephones Implementing the Wireless Application Protocol (WAP)

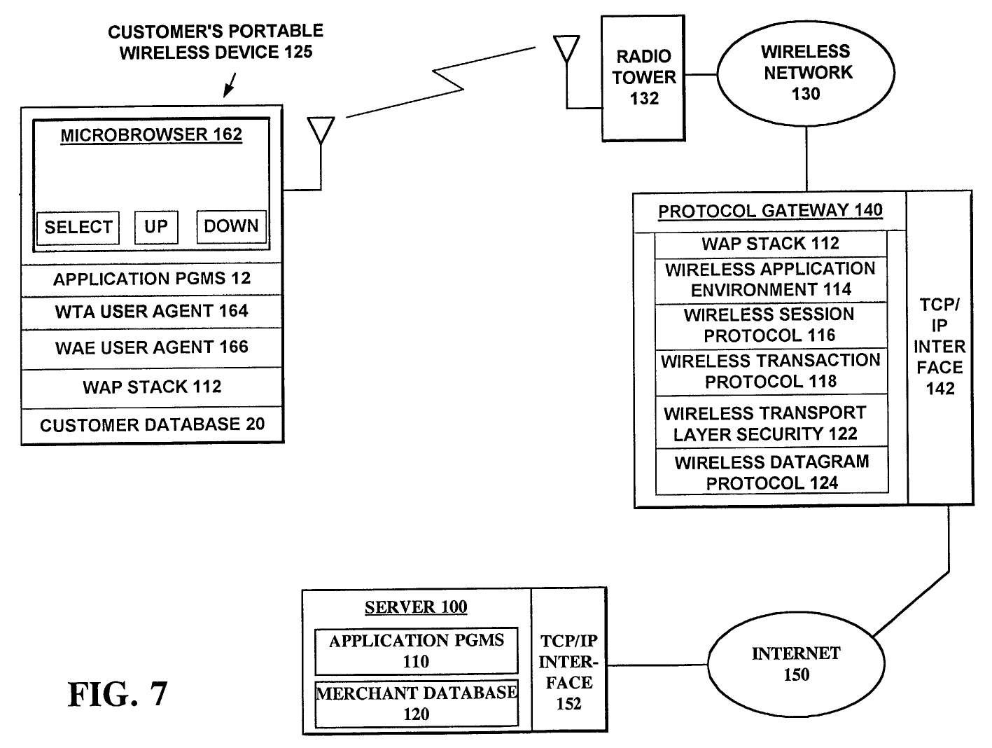

The method, system, business method, and computer program product can also be applied to wireless personal digital assistants (PDAs) and wireless telephones implementing the Wireless Application Protocol (WAP) standard. FIG. 7 is a network diagram of an alternate embodiment showing an example relationship between the customer's Wireless Application Protocol (WAP)-enabled portable wireless device 125, a WAP protocol gateway 140, and the server 100. The customer's WAP-enabled portable wireless device 125 can be a wireless mobile phone, pager, two-way radio, smartphone, personal communicator, or the like. The customer's WAP-enabled portable wireless device 125 accesses a small file called a deck which is composed of several smaller pages called cards which are small enough to fit into the display area of the device's microbrowser 162. The small size of the microbrowser 162 and the small file sizes accommodate the low memory constraints of the portable wireless device 125 and the low-bandwidth constraints of a wireless network 130. The cards are written in the Wireless Markup Language (WML) which is specifically devised for small screens and one-hand navigation without a keyboard. The WML language is scaleable from two-line text displays on the microbrowser 162 of a cellular telephone, up through graphic screens found on smart phones and personal communicators. The cards written in the WML language can include programs written in WMLScript, which is similar to JavaScript, but makes minimal demands on memory and CPU power of the device 125 because it does not contain many of the unnecessary functions found in other scripting languages. There are a number of operating systems that support the WAP-enabled wireless device 125, including PalmOS (an operating system from Palm, Inc.), EPOC (an operating system from Psion Software), Windows CE (a version of the Microsoft Windows operating system), OS/9 (an operating system from Microware Systems Corporation), and JavaOS (an operating system from Sun Microsystems, Inc). The customer's WAP-enabled portable wireless device 125 communicates with the radio tower 132 over a longer distance than the Bluetooth-enabled devices previously discussed, and can exchange messages for distances up to several kilometers. The types of wireless networks 130 supported by the WAP standard include Cellular Digital Packet Data (CDPD), Code-Division Multiple Access (CDMA), Global System for Mobile Communications (GSM), Time Division Multiple Access (TDMA), and the like.

The overall process of communication between the customer's WAP-enabled wireless device (the client) 125, through the WAP protocol gateway 140, to the server 100 resembles the way Web pages are served on the Internet using the HyperText Transfer Protocol (HTTP) or World Wide Web protocol:

[1] The customer presses a phone key on the customer's device 125 related to the Uniform Resource Locator (URL) of the server 100.

[2] The customer's device 125 sends the URL, via the radio tower 132 and the wireless network 130, to the gateway 140 using WAP protocols.

[3] The gateway 140 translates the WAP request into an HTTP request and sends it over the Internet 150 to the server 100, via the Transmission Control Protocol/Internet Protocol (TCP/IP) interfaces 142 and 152.

[4] The server 100 handles the request just like any other HTTP request received over the Internet. The server 100 either returns a WML deck or an HyperText Markup Language (HTML) page back to the gateway 140 using standard server programs written, for example in Common Gateway Interface (CGI) programs, Java servlets, or the like.

[5] The gateway 140 receives the response from the server 100 on behalf of the customer's device 125. If the response is an HTML page, it gets transcoded into WML if necessary. Then the WML and WMLScript coding is encoded into a byte code that is then sent to the customer's device 125.

[6] The customer's device 125 receives the response in the WML byte code and displays the first card in the deck on the microbrowser 162 to the customer.

In FIG. 7, the protocol gateway 140 includes the WAP protocol stack 112. The WAP protocol stack 112 is organized into five different layers. The application layer is the wireless application environment 114, which executes portable applications and services. The session layer is the wireless session protocol 116, which supplies methods for the organized exchange of content between client/server applications. The transaction layer is the wireless transaction protocol 118, which provides methods for performing reliable transactions. The security layer is wireless transport layer security 122, which provides authentication, privacy, and secure connections between applications. The transport layer is the wireless datagram protocol 124, which shelters the upper layers from the unique requirements of the diverse wireless network protocols, such as CDPD, CDMA, GSM, etc. Additional information about the WAP standard and the WAP protocol stack can be found in the book by Charles Arehart, et al. entitled, “Professional WAP”, published by Wrox Press Ltd., 2000 (ISBN 1-861004-04-1).

In FIG. 7, the customer's portable wireless device 125 includes the microbrowser 162 that displays control buttons “UP”, “DOWN”, and “SELECT”, to enable the customer to navigate through the cards being displayed and to select options that are programmed by the application programs 12. The customer's device 125 also includes the wireless application environment (WAE) user agent 166 that renders the content for display on the microbrowser 164. Also included in the customer's device 125 is the wireless telephony applications (WTA) user agent 164 that receives compiled WTA files from the WTA server and executes them. Also included in the customer's device 125 is the WAP protocol stack 112 which has been previously discussed. The customer's device 125 includes the customer database 20 that stores the customer's private data concerning merchandise and services bought from the merchant in the past.

The sequence of operational steps carried out by the customer's Wireless Application Protocol (WAP)-enabled portable device 125 and the server 100 is similar to FIG. 3, with the principal difference being that the customer's Wireless Application Protocol (WAP)-enabled portable device 125 and the server 100 communicate directly through the radio tower 132, wireless network 130, and protocol gateway 140. Thus the server 100 directly receives the customer's query in step 304′ and sends the request for customer data directly to the customer in step 306′. Additionally, the server 100 directly processes the customer's order and payment authorization in step 326′. The customer's order and payment authorization can also be forwarded by the server 100 to the merchant's order processing computer (not shown), where the customer's order and payment can be processed.

There are many additional applications and features of the invention. The server can broadcast fee structures, payment, promotion and other information to many customers at the same time. The customer data sent by the customer to the server can be certified records that mask the customer's identity, so as to maintain the customer's anonymity. Other merchant services can include parking garage services and cellular telephone services. The server can categorize the transaction, for example as a personal or a business expense for the customer. The server can provide a personalized offer to the customer, such as recommending a specific piece of merchandise to purchase based upon past customer behaviors.

The method, system, business method, and computer program product thereby provides customers and merchants to quickly and automatically carry out the offer, acceptance, and delivery sequence for goods and services.

Although specific embodiments have been disclosed, it will be understood by those having skill in the art that changes can be made to that specific embodiment without departing from the spirit and the scope of the invention.

What is claimed is:

1. A method for providing to customers and merchants a quick and automatic way to carry out an offer, acceptance, and delivery sequence for goods, comprising:
receiving data at a server from a communication device associated with a customer, said data concerning preferences of the customer for goods available from the merchant; and
checking inventory for goods as characterized by said data and computing a price for the goods.

2. The method of claim 1, which further comprises:
receiving a payment authorization from the customer's device and providing to the customer the goods.

3. The method of claim 1, which further comprises:
checking a message authentication code for said data.

4. The method of claim 1, which further comprises:
checking a digital signature for said data.

5. The method of claim 1, wherein said step of receiving data further comprises:
transmitting the data from a portable communications device held by the customer to another communications device associated with the merchant.

6. The method of claim 5, wherein said portable communications device is a radio communications device.

7. The method of claim 5, wherein said portable communications device is a Bluetooth-enabled radio communications device.

8. The method of claim 5, wherein said portable communications device is a Wireless Application Protocol (WAP)-enabled radio communications device.

9. A system for providing to customers and merchants a quick and automatic way to carry out an offer, acceptance, and delivery sequence for goods, comprising:
a portable wireless device associated with a customer;
a fixed position wireless device associated with a merchant and in communication with said portable wireless device;
said portable wireless device and said fixed position wireless device exchanging data concerning data concerning preferences of the customer for goods available from the merchant; and
a server coupled to said fixed position wireless device, checking inventory for goods as characterized by said data and computing a price for the goods.

10. The system of claim 9, which further comprises:
said server receiving a payment authorization from the customer's device and providing to the customer the goods.

11. A computer program product for providing to customers and merchants a quick and automatic way to carry out an offer, acceptance, and delivery sequence for goods, comprising:
a computer readable medium;
program code in said computer readable medium for receiving data from a customer's device concerning data concerning preferences of the customer for goods available from the merchant; and
program code in said computer readable medium for checking inventory for goods as characterized by said data and computing a price for the goods.

12. The computer program product of claim 11, which further comprises:
program code in said computer readable medium for receiving a payment authorization from the customer's device and providing to the customer the goods.

13. A business method for providing to customers and merchants a quick and automatic way to carry out an offer, acceptance, and delivery sequence for goods, comprising:
receiving data from an communication device associated with a customer, said data concerning preferences of the customer for goods available from the merchant; and
checking inventory for goods as characterized by said data and computing a price for the goods.

14. The business method of claim 13, which further comprises:
receiving a payment authorization from the customer's communication device and providing to the customer the goods.

15. A method for providing to customers and merchants a quick and automatic way to carry out an offer, acceptance, and delivery sequence for goods, comprising:
receiving data at a server from an insitu communication device associated with a customer, said data concerning preferences of the customer for goods available from the merchant; and
checking inventory for goods as characterized by said data and computing a price for the goods.

16. The method of claim 15, which further comprises:
receiving a payment authorization from the customer's device and providing to the customer the goods.

17. A system for providing to customers and merchants a quick and automatic way to carry out an offer, acceptance, and delivery sequence for goods, comprising:
a portable wireless insitu device associated with a customer;
a fixed position wireless device associated with a merchant and in communication with said portable wireless device;
said a portable insitu wireless device and said fixed position wireless device exchanging data concerning data concerning preferences of the customer for goods available from the merchant; and
a server coupled to said fixed position wireless device, checking inventory for goods as characterized by said data and computing a price for the goods.

18. The system of claim 17, which further comprises:
said server receiving a payment authorization from the customer's potable wireless insitu device and providing to the customer the goods.

19. A computer program product for providing to customers and merchants a quick and automatic way to carry out an offer, acceptance, and delivery sequence for goods, comprising:
a computer readable medium;
program code in said computer readable medium for receiving data from a customer's insitu device concerning data concerning preferences of the customer for goods available from the merchant; and
program code in said computer readable medium for checking inventory for goods as characterized by said data and computing a price for the goods.

20. The computer program product of claim 19, which further comprises:
program code in said computer readable medium for receiving a payment authorization from the customer's insitu device and providing to the customer the goods.

21. A business method for providing to customers and merchants a quick and automatic way to carry out an offer, acceptance, and delivery sequence for goods, comprising:
receiving data from an insitu communication device associated with a customer, said data concerning preferences of the customer for goods available from the merchant; and
checking inventory for goods as characterized by said data and computing a price for the goods.

22. The business method of claim 21, which further comprises:
receiving a payment authorization from the customer's insitu communication device and providing to the customer the goods.
